(19) United States
(12) Patent Application Publication
(10) Pub. No.: US 2025/0382836 A1
(43) Pub. Date: Dec. 18, 2025

(54) ELECTRO-MAGNETIC DAMPER FOR MANUAL OPERATED TAILGATE

(71) Applicant: Honda Motor Co., Ltd., Tokyo (JP)

(72) Inventor: Tushar Jagannath PAWAR, Plain City, OH (US)

(21) Appl. No.: 18/740,943

(22) Filed: Jun. 12, 2024

(51) Int. Cl. E05F 5/06; B62D 33/027; E05D 3/02; H02K 49/04

(52) U.S. Cl. CPC E05F 5/06; B62D 33/0273; E05D 3/02; H02K 49/046; E05Y 2201/21; E05Y 2201/234; E05Y 2201/246; E05Y 2201/266; E05Y 2201/408; E05Y 2201/438; E05Y 2201/462; E05Y 2900/544

(57) ABSTRACT

A damper assembly for a tailgate on a vehicle includes a tailgate and a hinge pin rotatably connecting the tailgate to a vehicle body for pivotal movement between a closed position and an open position. The damper assembly additionally includes a rotor rotatably connected to the hinge pin so as to rotate together with the hinge pin, and a magnet arranged adjacent to the rotor for generating an eddy current to damp rotation of the hinge pin and thereby damp pivotal movement of the tailgate.

### BACKGROUND

Closures on vehicles have increased significantly in weight in recent years as more features and functions are included on vehicle closures. One such closure is the tailgate found on trucks, particularly open bed trucks (i.e., pickup trucks). For example, some tailgates on trucks include various hinges and brackets to enable the tailgate to open along multiple axes. Some tailgates include retractable stepping devices (e.g., ladders), additional folding members, various holders (e.g., tool holders, cup holders and more), etc. All of these features tend to increase the weight of the tailgate. This can hinder opening of the tailgate as dampers may be limited in size and/or capacity due to various limitations of the vehicle design. For example, there may not be enough packaging space for the size of gas trusts, torsion bars and/or springs that would be required to properly damp a heavy tailgate when using conventional damper assemblies.

### BRIEF DESCRIPTION

According to one aspect, a damper assembly for a tailgate on a vehicle includes a tailgate and a hinge pin rotatably connecting the tailgate to a vehicle body for pivotal movement between a closed position and an open position. The damper assembly additionally includes a rotor rotatably connected to the hinge pin so as to rotate together with the hinge pin, and a magnet arranged adjacent to the rotor for generating an eddy current to damp rotation of the hinge pin and thereby damp pivotal movement of the tailgate.

According to another aspect, a vehicle tailgate damper system includes a tailgate, a rotor, and a magnet. The tailgate is hingedly connected to a vehicle body for pivotal movement between a closed position and an open position. The rotor is secured to the tailgate for rotation therewith when the tailgate is moved between the closed position and the open position. The magnet is annularly disposed about the rotor and arranged together with the rotor to generate an eddy current having an eddy rotational direction that is opposite a rotational direction of the tailgate.

According to a further aspect, a vehicle hinge system includes a movable closure disposed on an associated vehicle, and a hinge pin rotatably connecting the closure to the associated vehicle for pivotal movement between a closed position and an open position. The vehicle hinge system further includes a rotor rotatably connected to the hinge pin so as to rotate together with the hinge pin, and a magnet annularly disposed about the rotor and arranged together with the rotor to generate an eddy current having an eddy rotational direction that is opposite a rotational direction of the closure.

### BRIEF DESCRIPTION OF THE DRAWINGS

FIG. 1 is schematic perspective view of a damper assembly for a tailgate on a vehicle according to an exemplary embodiment.

FIG. 2 is a partially exploded perspective view of the damper assembly of FIG. 1.

FIG. 3 is a schematic front elevation view of the damper assembly of FIG. 1.

FIG. 4 is a schematic top plan view of the damper assembly of FIG. 1.

FIG. 5 is a cross-section view of the damper assembly taken along the line 5-5 of FIG. 4.

FIG. 6 is a cross-section similar to FIG. 5 but showing a bracket of the damper assembly connected to a D-pillar of the vehicle.

FIG. 7 is a cross-section view similar to FIG. 5 but showing the magnet according to an alternate exemplary embodiment.

FIG. 8 is a cross-sectional view, similar to FIG. 5, but showing a mounting arrangement for the magnet to secure the magnet to the vehicle.

### DETAILED DESCRIPTION

It should of course be understood that the description and drawings herein are merely illustrative, and that various modifications and changes can be made in the structures disclosed without departing from the present disclosure. Spatially defined terms may be used to describe an element and/or feature's relationship to other element(s) and/or feature(s) as, for example, illustrated in the figures. Moreover, any term of degree used herein, such as “substantially” and “approximately,” means a reasonable amount of deviation of the modified word is contemplated such that the end result is not significantly changed.

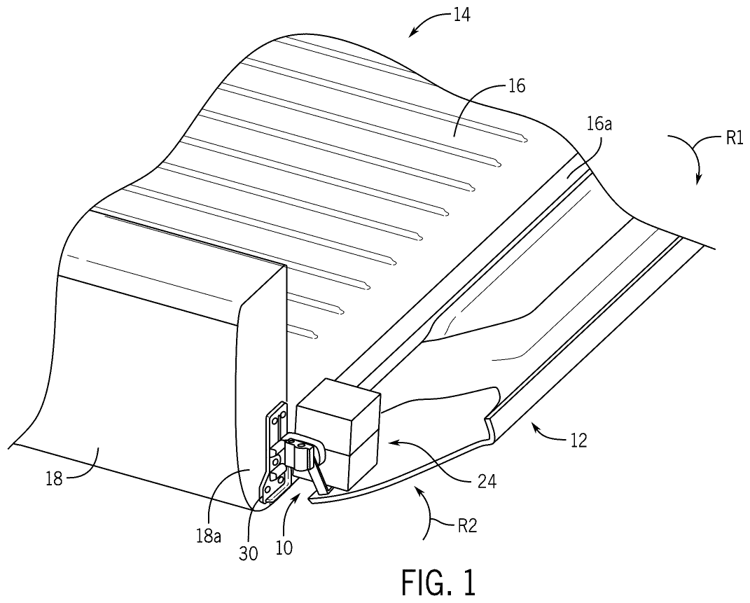

Referring now to the drawings, wherein like numerals refer to like parts throughout the several views, FIG. 1 illustrates a damper assembly 10 for a tailgate 12 on a vehicle 14 according to one embodiment of the present disclosure. The damper assembly 10 can be used in association with and/or include the tailgate 12, which can be the tailgate as shown in the illustrated embodiment or any other tailgate or movable closure secured to and/or disposed on the vehicle 14, or on some other vehicle. As shown in the illustrated embodiment, the tailgate 12 can be of the type often found on open-bed type vehicles, such as so-called pick up truck vehicles, though this is not required. Together, the tailgate 12 (or some other movable closure on the vehicle 14 or a movable closure on some other vehicle) and the damper assembly 10 can be referred to collectively as a vehicle hinge system.

As shown in the illustrated embodiment, the tailgate 12 can be mounted at or near a rearward edge 16a of a bed floor 16. The tailgate 12 can be rotatably secured or hingedly connected to the vehicle 14, and particularly to the bed floor 16 of the vehicle 14, so as to be pivotal or rotatable between a closed position in which the tailgate 12 is substantially oriented in a perpendicular relationship relative to the bed floor 16 and an open position wherein in the tailgate 12 lies flat in an approximate parallel relationship with the bed floor 16, as is known and understood by those skilled in the art. Movement of the tailgate 12 from the closed position to or toward the open position is illustrated as first rotational direction R1 and movement of the tailgate 12 from the open position to or toward the closed position is illustrated as second rotational direction R2, which is opposite the first rotational direction R1. In particular, the tailgate 12 can be hingedly connected to a D-pillar 18a of a vehicle body 18 of the vehicle 14. Optionally, the tailgate 12 can be further hingedly connected to a second D-pillar (not shown) opposite the D-pillar 18a. In one embodiment, the tailgate 12 can be a manually operated tailgate requiring a manual force to be applied to the tailgate 12 for moving the tailgate between the open and closed positions.

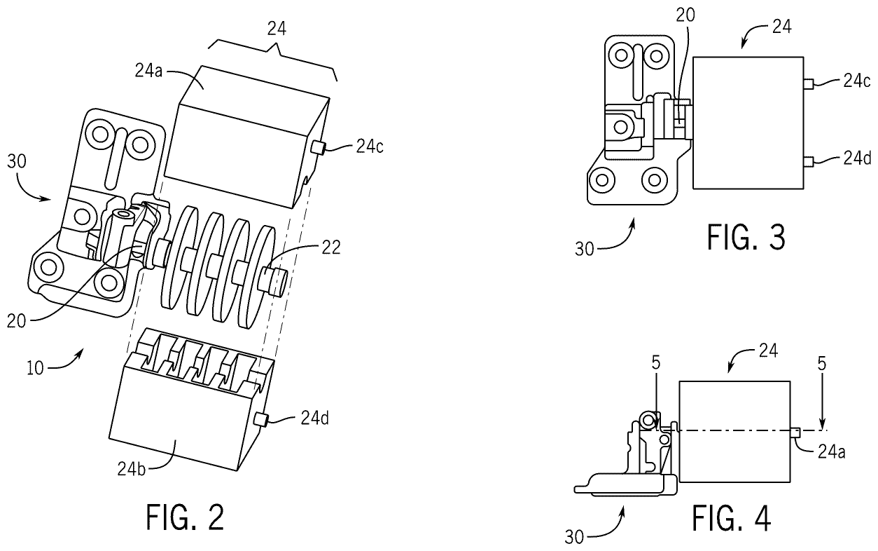

With additional reference to FIGS. 2-6, the damper assembly 10, which can also be referred to as a vehicle tailgate damper system when used in association with a tailgate, such as tailgate 12, includes a hinge pin 20 rotatably connecting the tailgate 12 to the vehicle body 18 of the vehicle 14 for pivotal movement between the closed position and the open position. The damper assembly 10 also includes a rotor 22 and a magnet or magnet assembly 24. The rotor 22 can be rotatably connected to the hinge pin 20 and thereby secured to the tailgate 12 so as to rotate together with the hinge pin 20 and the tailgate 12 when the tailgate 12 is moved between the closed position and the open position. The magnet 24 can be arranged adjacent the rotor 22 for generating an eddy current EC to damp rotation of the hinge pin 20 and thereby damp pivotal movement of the tailgate 12 as will be described in more detail below. In particular, the magnet 24 can be annularly disposed about the rotor 22 and arranged together with the rotor 22 to generate the eddy current having an eddy rotational direction that is opposite the rotational direction of the tailgate (e.g., opposite the first rotational direction R1 and thus the same as the second rotational direction R2).

The damper assembly 10 can additionally include a mounting bracket 30 secured to the vehicle body 18 for rotatably receiving the hinge pin 20. More particularly, the hinge pin 20 can be connected to the tailgate 12 for rotation therewith when the tailgate 12 is pivoted between the open position and the closed position. More specifically, in one embodiment, the vehicle body 18 to which the mounting bracket 30 is mounted can be the D-pillar 18a of the vehicle 14 as shown in the illustrated embodiment. Accordingly, the mounting bracket 30 is fixedly secured to the vehicle body 18 to allow relative rotation by the tailgate 12. The mounting bracket 30 will be described in further detail below.

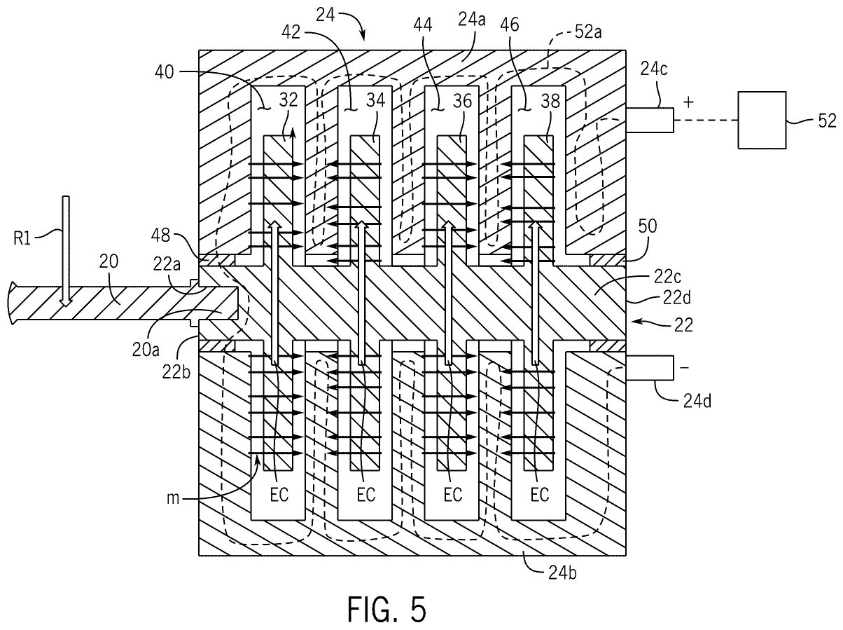

With specific reference to FIG. 5, the rotor 22 and the hinge pin 20 can be axially and rotatably fixed relative to one another. Accordingly, rotation of the hinge pin 20 results in corresponding rotation of the rotor 22. In particular, the hinge pin 20 and the rotor 22 can be rotated in the first rotational direction R1 that corresponds to pivotal movement of the tailgate 12 from the closed position to the open position, and the second rotational direction R2 that is opposite the first direction R1 that corresponds to pivotal movement of the tailgate 12 from the open position to the closed position. As shown, the rotor 22 can include an axial bore 22a defined therein at one end 22b in which one end 20a of the hinge pin 20 is received. The end 20a of the hinge pin 20 can include a circumferential flange 20b that abuts the end 22b of the rotor 22. The rotatable fixing between the hinge pin 20 and the rotor 22 can be by any known connecting method, for example welding, a keyed connection, a splined connection, etc. As will be described detail below, the hinge pin 20 can be connected to the tailgate 12 for rotation therewith when the tailgate 12 is pivoted between the open position and the closed position such that the tailgate 12 and the hinge pin 20 rotate together.

The hinge pin 20, the rotor 22 and the magnet 24 will each be described in more detail. In the illustrated embodiment of FIGS. 1-6, the magnet 24 can be an electromagnet that is selectively activated only when the tailgate 12 is rotated from the closed position to the open position in the first rotational direction R1. As shown, the magnet 24 can include first magnet half 24a and second magnet half 24b that together encapsulate or surround the rotor 22. As shown, the magnet halves 24a, 24b can respectively have terminals 24c, 24d to which an electrical current can be provided to selectively activate the magnet 24. For example, a positive current can be supplied to the terminal 24c of the magnet half 24a from a power source 52 on the vehicle 14 (e.g., a battery) to energize and activate the magnet 24 as schematically illustrated by current 52a. Such activation and energization of the magnet 24b can be selectively applied, for example, only when the tailgate 12 is moved from the open position to the closed position. In contrast, the magnet 24 can be de-energized or remain deactivated when the tailgate 12 is moved from the open position to the closed position. As will be described in more detail below, the magnet 24 can be fixed to the vehicle body 18 so the tailgate 12, the hinge pin 20 and the rotor 22 together rotate relative to the bracket 30 and the magnet 24.

As shown in the illustrated embodiment, the rotor 22 can include shaft portion 22c defining the end 22b as a first axial end with an opposite axial end 22d disposed opposite the first axial end 22b. The rotor 22 can further include at least one radio disc, such as discs 32, 34, 36, 38 in the illustrated embodiment, that are disposed along the shaft portion 22c. The first and second magnet halves 24a, 24b can together define the at least one disc chambers (i.e., disc chambers 40, 42, 44, 46) in which the at least one radial disc (i.e., discs 32, 34, 36, 38) is disposed. More particularly, each of the at least one radial disc 32, 34, 36, 38 can be disposed in a corresponding one of the at least one disc chamber, such as corresponding disc chambers 40, 42, 44, 46 of the magnet 24. Within the chambers 40, 42, 44, 46, the eddy current EC is generated by the current 52a and to act on the discs 32, 34, 36, 38 to inhibit rotation of the at least one radial disc 32, 34, 36, 38 and thereby inhibit rotation of the hinge pin 20 and the tailgate 12, such that movement of the tailgate 12 from the close position to the open position is damped.

In one embodiment, the at least one radial disc of the rotor 22 includes at least two radial disks, such as any two of the discs 32, 34, 36, 38, axially spaced apart from one another along the shaft portion 22c. As shown in the illustrated embodiment, the at least one radio disc includes four axially spaced apart discs 32, 34, 36, 38, though it is to be appreciated that fewer than four or more than four discs could be provided. The radial discs 40, 42, 44, 46 are disposed along the rotor 22 and in the disc chambers 40, 42, 44, 46 to provide surfaces on which the eddy current ECs can act. Bearings 48, 50 can be annually disposed between the rotor 22 and the magnet 24, particularly at each of the ends 22b, 22d of the rotor 22, to enable rotation of the rotor 22 relative to the magnet 24.

In operation, the magnet 24 is energized when the tailgate 12 is moved in the first rotational direction R1. When the tailgate 12 is moved in the first rotational direction R1, the hinge pin 20 and the rotor 22 are also moved in the first rotational direction R1 (as schematically illustrated in FIG. 5). That is, current from the power source 52 is supplied to the terminal 24c to energize and activate the magnet 24 when the tailgate 12, the hinge pin 20 and the rotor 22 are moved in the first rotational direction R1. Such activation causes the magnet 24 to generate magnetic forces relative to the discs 32, 34, 36, 38 as illustrated by arrows M and these magnetic forces provide eddy currents ECs in the disc chambers 40, 42, 44, 46. These eddy currents ECs have a rotational direction that is opposite the rotational direction R1 of the tailgate 12 as the tailgate 12 is moved from the closed position to or toward the open position (i.e., the eddy currents ECs flow the same as the second rotational direction R2). The eddy currents ECs counteract or counterbalance the weight of the tailgate 12 as it is moved to the fully open position thereby damping movement of the tailgate 12. When the tailgate 12 is moved in the second rotational direction R2, such as when the tailgate 12 is moved from the open position back to the closed position, no energization of the magnet 24 occurs so the hinge pin 20 and the rotor 22 rotate together with the tailgate 12 and no eddy currents are provided in the chambers 40, 42, 44, 46.

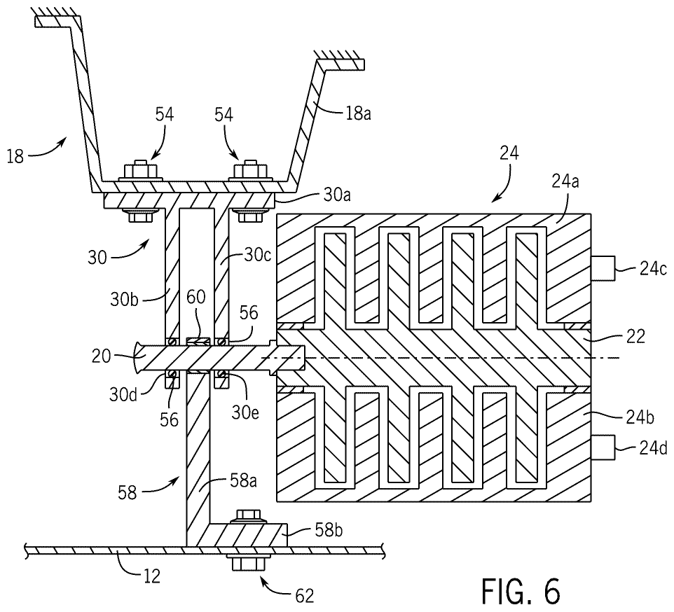

With specific reference to FIG. 6, the rotatable connection between the tailgate 12 and the vehicle body 18 will be described in more detail. In the illustrated embodiment, the bracket 30 includes a base portion 30a and a pair of support arms 30b, 30c. The base portion 30a can be fixedly secured to the D-pillar 18a via suitable fasteners 54, which can be threaded members secured via nuts for example. The support arms 30b, 30c extend orthogonally from the base portion 30a and define respective hinge pin apertures 30d, 30e. The hinge pin 20 is received through hinge pin apertures 30d, 30e and is rotatably disposed relative to the support arms 30b, 30c, and more generally is rotatably disposed relative to the bracket 30. Optionally, a bearing or bearing members (e.g., roller ball bearings 56) can be disposed in the apertures 30d, 30e annularly between the support arms 30b, 30c and the hinge pin 20.

A hinge arm 58 can be rotatably fixed to the hinge pin 20, such as via a press fit or press fit bushing 60, so that the hinge arm 58 rotates together with the hinge pin 20. The hinge arm 58 can include an arm portion 58a and a mounting portion 58b. The arm portion 58a extends from the hinge pin 20 to the tailgate 12 and the mounting portion 58b secures the hinge arm 58 to the tailgate 12 via one or suitable fasteners 62, such as the illustrated threaded member and nut for example. Of course, other fastening arrangements and/or components can be used to secure the tailgate 12 to the hinge pin 20, and more generally to rotatably secure the tailgate 12 to the rotor 22.

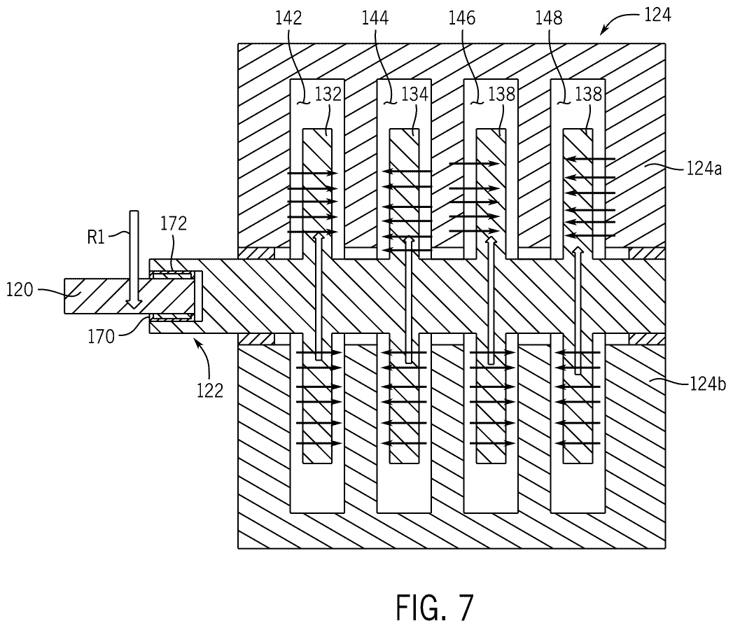

With reference now to FIG. 7, an alternate embodiment is illustrated wherein the hinge pin 20 and the rotor 22 are respectively replaced with the illustrated hinge pin 120 and rotor 122. Also, the magnet 24 and its magnet halves 24a, 24b are replaced with magnet 124 and its magnet halves 124a, 124b. The hinge pin 120 and the rotor 122 can be the same, respectively, as the hinge pin 20 and the rotor 22 except as discussed below. Likewise, the magnet 124 and magnet halves 124a, 124b can be the same as the magnet 24 and the magnet halves 24a, 24b except as discussed below.

As shown, the rotor 122 and the hinge pin 120 can be axially fixed relative to one another with a clutch 170 and bearing 172 each annually disposed between the rotor 122 and the hinge pin 120 such that the rotor 122 only rotates together with the hinge pin 120 when the hinge pin 120 is rotated in the first rotatable direction R1. Thus, the clutch 170 is mechanically disposed between the tailgate 12 and the rotor 122 to selectively couple and decouple the tailgate 12 from the rotor 122 to thereby transmit or not transmit rotation of the tailgate to the rotor. In particular, the clutch 170 can be a mechanical clutch 170 that only transmits rotational force from the hinge pin 120 to the rotor 122, and thus from the tailgate 12 to the rotor 122, when the tailgate 12 is moved from the closed position to the open position. When the tailgate is moved from the open position to the closed position, the clutch 170 transmits no rotational force from the hinge pin 120 to the rotor 122 and thus the hinge pin 120 rotates freely relative to the rotor 122. Accordingly, the clutch 170 allows relative rotation between the rotor 122 and the hinge pin 120 when the hinge pin 120 is rotated in the second rotational direction R2 that is opposite the first rotation direction R1.

Since the rotor 122 is rotatably decoupleable from the hinge pin 120 and thereby from the tailgate 12 in the embodiment of FIG. 5 when the tailgate 12 is moved from the open position to the closed position, the magnet 124 can be a permanent magnet and requires no selective energization. That is, the rotor 122 is decoupled from the hinge pin 120 when the tailgate is rotated from the open position to the closed position. This allows the ECs to still be formed in the chambers 142, 144, 146, 148 and act on the radial discs 132, 134, 136, 138 of the rotor 122 but such acting on the rotor 122 has no damping effect on the tailgate 12 due to the rotational freedom afforded between the hinge pin 120 and the rotor 122 via the clutch 170 when the tailgate is rotated in the second rotational direction R2.

Like the magnet 24, the magnet 124 can be fixed to the vehicle body 18 so the tailgate 12 and the hinge pin 120 together rotate relative to the bracket 30 and the magnet 124. Also, the rotor 122 rotates relative to the bracket 30 and the magnet 124 but only when rotatably fixed to the hinge pin 120 by the clutch 170.

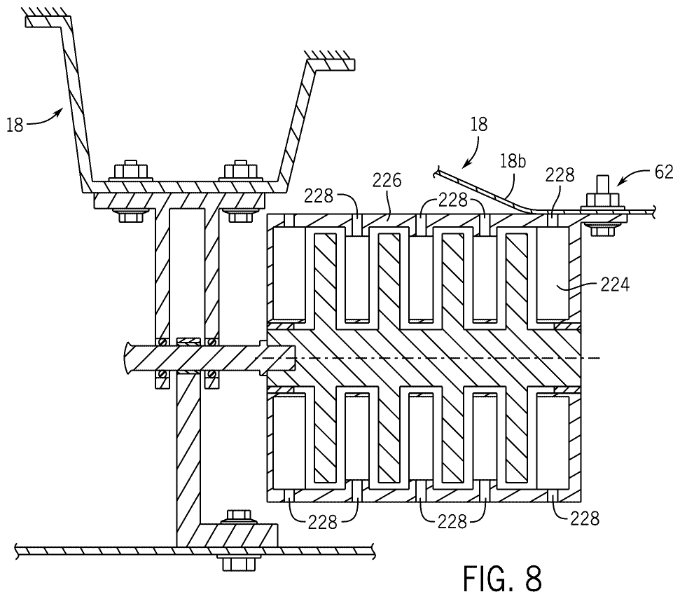

With reference now to FIG. 8, an embodiment is schematically illustrated to show one example of how the magnet 224 can be fixed to the vehicle body 18. Except as mentioned below, the embodiment of FIG. 8 can be the same or similar to the embodiment(s) of FIGS. 1-6 and/or FIG. 7. In the embodiment of FIG. 8, the magnet 224 can be accommodated within a housing 226 and the housing 226 is itself fixedly secured to the vehicle body 18. For example, the housing 226 can be secured to a flange portion 18b of the vehicle body 18 via one or more suitable fasteners 62, such as the illustrated threaded member and nut. Of course, other fastening arrangements and fastener types could be used to secured the housing 226 to the vehicle body 18. Additionally, additional fasteners such as the illustrated grub screw fasteners 228 can be used to secure the magnet 224 to and/or within the housing 226. In one example, the magnet 224 can be slide fit within the structure of the housing 226. Of course, it is to be appreciated that other arrangements can be employed for securing any of the magnets (e.g., magnets 24, 124, 224) to the vehicle body 18 to allow the rotor (e.g., rotors 22, 122) to rotate relative to the magnet when the tailgate is moved from the closed position to the open position.

It will be appreciated that various of the above-disclosed and other features and functions, or alternatives or varieties thereof, may be desirably combined into many other different systems or applications. Also that various presently unforeseen or unanticipated alternatives, modifications, variations or improvements therein may be subsequently made by those skilled in the art which are also intended to be encompassed by the following claims.

1. A damper assembly for a tailgate on a vehicle, comprising:
the tailgate;
a hinge pin rotatably connecting the tailgate to a vehicle body for pivotal movement between a closed position and an open position;
a rotor rotatably connected to the hinge pin so as to rotate together with the hinge pin; and
a magnet arranged adjacent to the rotor for generating an eddy current to damp rotation of the hinge pin and thereby damp pivotal movement of the tailgate.

2. The damper assembly of claim 1 wherein the rotor and the hinge pin are axially fixed relative to one another with a clutch disposed between the rotor and the hinge pin such that the rotor only rotates together with the hinge pin when the hinge pin is rotated in a first rotatable direction.

3. The damper assembly of claim 2 wherein the clutch allows relative rotation between the rotor and the hinge pin when the hinge pin is rotated in a second rotatable direction that is opposite the first rotatable direction.

4. The damper assembly of claim 3 wherein the first rotatable direction corresponds to pivotal movement of the tailgate from the closed position to the open position, and wherein the second rotatable direction corresponds to pivotal movement of the tailgate from the open position to the closed position.

5. The damper assembly of claim 2 wherein the first rotatable direction corresponds to pivotal movement of the tailgate from the closed position to the open position.

6. The damper assembly of claim 2 wherein the rotor includes an axial bore at one end thereof in which one end of the hinge pin is received, and wherein the clutch is annularly arranged between the hinge pin and the rotor.

7. The damper assembly of claim 1 wherein the hinge pin is connected to the tailgate for rotation therewith when the tailgate is pivoted between the open position and the closed position.

8. The damper assembly of claim 1 further including:
a mounting bracket secured to the vehicle body for rotatably receiving the hinge pin, wherein the hinge pin is connected to the tailgate for rotation therewith when the tailgate is pivoted between the open position and the closed position.

9. The damper assembly of claim 1 wherein the magnet is an electromagnet that is activated only when the tailgate is rotated from the closed position to the open position.

10. The damper assembly of claim 1 wherein the rotor includes a shaft portion and at least one radial disc disposed along the shaft portion, the at least one radial disc disposed in at least one disc chamber of the magnet in which the eddy current is generated to inhibit rotation of the at least one radial disc and thereby inhibit rotation of the hinge pin and the tailgate such that movement of the tailgate from the closed position to the open position is damped.

11. The damper assembly of claim 10 wherein the at least one radial disc includes at least two radial discs axially spaced apart along the shaft portion.

12. The damper assembly of claim 10 wherein the magnet includes a first magnet and a second magnet, the first and second magnets together defining the at least one disc chamber in which the at least one radial disc is received.

13. The damper assembly of claim 1 wherein the tailgate is a manually operated tailgate requiring a manual force to be applied to the tailgate for moving the tailgate between the open position and the closed position.

14. A vehicle tailgate damper system, comprising:
a tailgate hingedly connected to a vehicle body for pivotal movement between a closed position and an open position;
a rotor secured to the tailgate for rotation therewith when the tailgate is moved between the closed position and the open position; and
a magnet annularly disposed about the rotor and arranged together with the rotor to generate an eddy current having an eddy rotational direction that is opposite a rotational direction of the tailgate.

15. The vehicle tailgate damper system of claim 14 wherein the rotor is rotatably decouplable from the tailgate when the tailgate is moved from the open position to the closed position so that the rotor does not rotate together with the tailgate when moved from the open position to the closed position.

16. The vehicle tailgate damper system of claim 15 further including a clutch disposed between the tailgate and the rotor to selectively couple and decouple the tailgate from the rotor.

17. The vehicle tailgate damper system of claim 16 further including a hinge pin rotatably connecting the tailgate to the vehicle body, the hinge pin selectively coupled to the rotor via the clutch wherein the clutch is annually disposed between the rotor and the hinge pin.

18. The vehicle tailgate damper system of claim 14 wherein the magnet is fixed to the vehicle body.

19. A vehicle hinge system, comprising:
a movable closure disposed on an associated vehicle;
a hinge pin rotatably connecting the closure to the associated vehicle for pivotal movement between a closed position and an open position;
a rotor rotatably connected to the hinge pin so as to rotate together with the hinge pin; and
a magnet annularly disposed about the rotor and arranged together with the rotor to generate an eddy current having an eddy rotational direction that is opposite a rotational direction of the closure.

20. The vehicle hinge system of claim 19 wherein the closure is a tailgate hingedly connected to a D-pillar of the associated vehicle.
